(19) United States
(12) Patent Application Publication
(10) Pub. No.: US 2012/0218331 A1
(43) Pub. Date: Aug. 30, 2012

(54) LIQUID EJECTING APPARATUS AND DRIVING METHOD THEREOF

(75) Inventor: Toshiki USUI, Shiojiri-shi (JP)

(73) Assignee: SEIKO EPSON CORPORATION, Shinjuku-ku (JP)

(21) Appl. No.: 13/407,677

(22) Filed: Feb. 28, 2012

(30) Foreign Application Priority Data
Feb. 28, 2011 (JP) 2011-041499

(51) Int. Cl. B41J 29/38

(52) U.S. Cl. 347/9

(57) ABSTRACT

A liquid ejecting apparatus includes a recording head including a first pressure chamber filled with a first liquid, a first nozzle communicating with the first pressure chamber, a first pressure generating element changing pressure in the first pressure chamber and ejecting the first liquid from the first nozzle, a second pressure chamber filled with a second liquid, a second nozzle communicating with the second pressure chamber, and a second pressure generating element changing pressure in the second pressure chamber and ejecting the second liquid from the second nozzle; and a control unit supplying an ejection pulse of a first frequency to the first pressure generating element to eject the first liquid from the first nozzle, and supplying an ejection pulse of a second frequency lower than the first frequency to the second pressure generating element to eject the second liquid from the second nozzle.

### BACKGROUND

1. Technical Field

The present invention relates to a technique for ejecting liquid such as ink.

2. Related Art

A liquid ejecting technique for ejecting liquid (for example, ink) of a pressure chamber from a nozzle by vibrating the inside of a pressure chamber using a pressure generating element such as a piezoelectric vibrator or a heating element has previously been proposed. In addition to ink dyes and ink pigments, photoluminescent ink (metallic ink), which is capable of providing a metallic gloss to a printed image, and the like have been used in the liquid ejecting technique.

Since the ink characteristics are different for each kind of ink, it is preferable to control ejection according to the kind of ink. For example, in JP-A-2001-315324, taking into consideration the fact that the necessary ink ejection amount to form dots of the same size is different for dye ink and pigment ink, the ejection amount is differentiated for each kind of ink by differentiating the number of times of supply of a driving waveform (ejection pulse) according to the various kinds of ink to be ejected.

Here, the optimum driving frequency differs according to the characteristics of the ink (viscosity and the like). For example, photoluminescent ink contains photoluminescent pigment such as metal particles or the like, whereby it is necessary to eject the ink using a driving signal with a lower frequency than a normal ink pigment. However, in the technique of JP-A-2001-315324 in which each ink is ejected using driving signals with the same frequency, since the frequency of the driving signal may not be appropriate depending on the ink, there may be cases where the desired ejection characteristics cannot be obtained, or cases where the ink is not ejected (missing pixels in the ink). In view of the above circumstances, the object of the invention is to appropriately eject ink with different characteristics.

### SUMMARY

An advantage of some aspects of the invention is that there is provided a liquid ejecting apparatus according to the invention including: a recording head provided with a first pressure chamber filled with a first liquid, a first nozzle communicating with the first pressure chamber, a first pressure generating element changing the pressure in the first pressure chamber and ejecting the first liquid in the first pressure chamber from the first nozzle, a second pressure chamber filled with a second liquid, a second nozzle communicating with the second pressure chamber, and a second pressure generating element changing the pressure in the second pressure chamber and ejecting the second liquid in the second pressure chamber from the second nozzle; and a control unit supplying an ejection pulse to the first pressure generating element at a first frequency to eject the first liquid from the first nozzle, and supplying an ejection pulse to the second pressure generating element at a second frequency lower than the first frequency to eject the second liquid from the second nozzle.

According to the above configuration, since the pressure generating element of the pressure chamber filled with the second liquid (second pressure generating element) is driven with a frequency which is low in comparison to the pressure generating element of the pressure chamber filled with the first liquid (first pressure generating element), there is an advantage in that fast ejection of the first liquid and appropriate ejection of the second liquid can be made compatible in comparison to a configuration in which the frequency driving the pressure generating element is the same for the first liquid and the second liquid.

It is preferable that the number of nozzles ejecting the second liquid be greater than the number of the first nozzles. According to the above configuration, it is possible to eject the second liquid at the same ejection frequency as the ejection frequency of the first liquid.

It is preferable that the liquid ejecting apparatus be provided with a driving signal generation unit generating a driving signal including the ejection pulse of each driving cycle, the control unit instructs the supply of the ejection pulse of each of the driving cycles with respect to the first pressure generating element and instructs the supply of the ejection pulse every predetermined number of driving cycles with respect to the second pressure generating element. According to the above configuration, since a different interval is selected from a common driving signal and the ejection pulse is supplied to each pressure generating element with a different frequency, it is possible to simplify the circuit configuration in comparison with a configuration provided with a unit for generating a driving signal separately for each frequency.

It is preferable that the recording head be further provided with a third pressure chamber filled with the second liquid, a third nozzle communicated with the second pressure chamber, and a third pressure generating element changing the pressure in the third pressure chamber and ejecting the second liquid in the third pressure chamber from the third nozzle, and the control unit supplies an ejection pulse of the first driving cycle in the plurality of driving cycles to the second pressure generating element, and supplies an ejection pulse of a second driving cycle different to the first driving cycle in the plurality of driving cycles to the third pressure generating element.

According to the above configuration, since the period of driving each pressure generating element is divided between the second pressure chamber and the third pressure chamber filled with the second liquid respectively, the driving load of the recording head is reduced in comparison with a configuration supplying the ejection pulse at the same time with respect to all of the pressure generating elements corresponding to the second liquid. Further, since the number of pressure generating elements supplying the ejection pulse at the same time is reduced (the storage components attached to the transmission path of the driving signal are reduced), there is an advantage in that distortion of the driving signal is suppressed.

It is preferable that the second liquid be a photoluminescent ink. In a more preferred embodiment, the photoluminescent ink contains photoluminescent pigment and has a lower viscosity than the first liquid. In a further preferred embodiment, the photoluminescent pigment is plate-shaped particles. In each of the above embodiments, photoluminescent ink having different characteristics to the first liquid is appropriately ejected from a nozzle.

The invention also specifies the operation method of the liquid ejecting apparatus relating to each of the above embodiments. According to another aspect of the invention, there is provided a driving method for a liquid ejecting apparatus including a recording head provided with a first pressure chamber filled with a first liquid, a first nozzle that communicates with the first pressure chamber, a first pressure generating element that changes the pressure in the first pressure chamber and ejects the first liquid in the first pressure chamber from the first nozzle, and a second pressure chamber filled with a second liquid, a second nozzle that communicates with the second pressure chamber, and a second pressure generating element that changes the pressure in the second pressure chamber and ejects the second liquid in the second pressure chamber from the second nozzle, the method including: supplying an ejection pulse of a first driving cycle to the first pressure generating element to eject the first liquid from the first nozzle; and supplying an ejection pulse of a second driving cycle lower than the first driving cycle to the second pressure generating element to eject the second liquid from the second nozzle. The above driving method also realizes the same operation and effects as the liquid ejecting apparatus according to an aspect of the invention.

### BRIEF DESCRIPTION OF THE DRAWINGS

The invention will be described with reference to the accompanying drawings, wherein like numbers reference like elements.

FIG. 1 is a partial schematic diagram of a printing apparatus relating to a first embodiment of the invention.

FIG. 2 is a plan diagram of a discharging surface of a recording head.

FIG. 3 is a configurational diagram of a recording head.

FIG. 4 is a block diagram of an electric configuration of a printing apparatus of the first embodiment.

FIG. 5 is a waveform diagram of a driving signal.

FIG. 6 is a block diagram of an electric configuration of a recording head.

FIG. 7 is a waveform diagram of an ejection signal.

FIG. 8 is a waveform diagram of an ejection signal of a second embodiment.

FIG. 9 is a block diagram of an electric configuration of a driving signal generation unit of a third embodiment.

FIG. 10 is waveform diagram of a basic waveform and driving signal of a third embodiment.

FIG. 11 is a waveform diagram of a basic waveform and driving signal of the third embodiment.

FIG. 12 is a waveform diagram of a driving signal of a modification.

### DESCRIPTION OF EXEMPLARY EMBODIMENTS

### A: First Embodiment

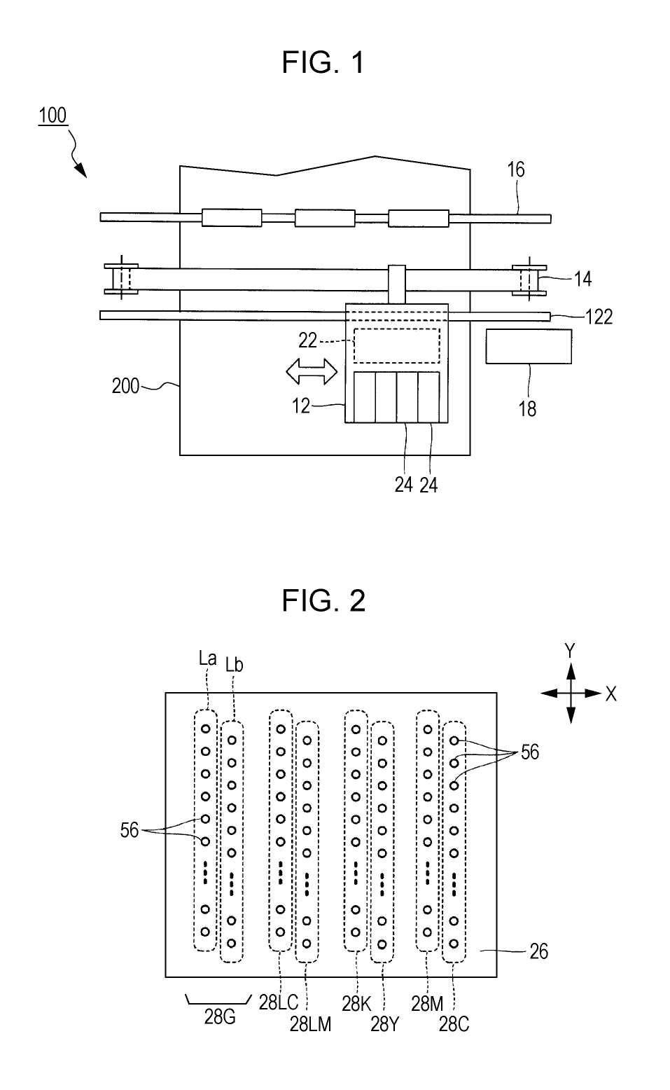

FIG. 1 is a partial schematic diagram of an ink jet type printing apparatus 100 relating to the first embodiment of the invention. The printing apparatus 100 is a liquid ejecting apparatus ejecting fine droplets of ink onto a recording paper 200, and is provided with a carriage 12, a movement mechanism 14 and a paper transporting mechanism 16.

In the carriage 12, in addition to the installation of a recording head 22 functioning as a liquid ejecting head, an ink cartridge 24 storing ink to be supplied to the recording head 22 is detachably mounted. In addition, it is possible to adopt a configuration in which the ink cartridge 24 is fixed to the housing of the printing apparatus 100 (not shown) and supplies ink to the recording head 22.

The movement mechanism 14 of FIG. 1 reciprocates the carriage 12 in the main scanning direction along the guide shaft 122 (width direction of the recording paper 200). The position of the carriage 12 is detected with a detector such as a linear encoder (not shown) and used for the control of the movement mechanism 14. The paper transporting mechanism 16 is aligned with the reciprocation of the carriage 12 and moves the recording paper 200 in the sub-scanning direction. The recording head 22 ejects ink onto the recording paper 200 during the reciprocation of the carriage 12, thereby recording (printing) a desired image on the recording paper 200.

The movement mechanism 14 is capable of moving the recording head 22 up to a position outside a range in which the discharge surface 26 faces the recording paper 200 (below referred to as a “shelter position”). The cap 18 is arranged so as to face the discharge surface 26 of the recording head 22 in the shelter position. The cap 18 seals the discharge surface 26 of the recording head 22. In the vicinity of the cap 18, a wiper (not shown) which wipes the discharge surface 26 is arranged.

FIG. 2 is a plan diagram of the discharging surface 26 facing the recording paper 200 in the recording head 22. The X direction in FIG. 2 is the main scanning direction and the Y direction is the sub-scanning direction. As shown in FIG. 2, in the discharge surface 26 of the recording head 22, a plurality of nozzle groups 28 (28C, 28M, 28Y, 28K, 28LM, 28LC, and 28G) are formed. Each nozzle group 28 is a collection of a plurality of nozzles 56. The nozzle group 28G has two sets of N nozzles 56 and each nozzle group 28 other than the nozzle group 28G has N nozzles 56. Further, the nozzle groups 28G respectively have two nozzle rows including N nozzles 56 (first row La and second row Lb). Ink is ejected from each nozzle 56 of the nozzle group 28. The plurality of nozzle groups 28 (28C, 28M, 28Y, 28K, 28LM, 28LC, and 28G) respectively correspond to a plurality of different ink colors (cyan (C), magenta (M), yellow (Y), black (K), light magenta (LM), light cyan (LC), and photoluminescent (G)).

Below, to simplify the description, inks other than the photoluminescent ink (cyan (C), magenta (M), yellow (Y), black (K), light magenta (LM), and light cyan (LC)) will be grouped together and referred to as “non-photoluminescent inks”.

Description will be given regarding the photoluminescent ink ejected from each nozzle 56 of the nozzle groups 28G. The photoluminescent ink of the present embodiment has low viscosity in comparison with the non-photoluminescent ink. The photoluminescent ink contains photoluminescent pigment and organic solvent. The photoluminescent ink is made of particles having photoluminescence and provides a metallic gloss to an image printed on the recording paper 200. When the particle shape of the photoluminescent pigment is plate shaped, the gloss providing effect is good. The material of the photoluminescent pigment is arbitrary; however, aluminum or aluminum alloy is preferable from the viewpoints of glossiness (photoluminescence) and cost. When an aluminum alloy is used, one or more arbitrary chemical elements having photoluminescence (preferably, silver, gold, platinum, nickel, chromium, tin, zinc, indium, titanium, copper, and the like) may be added to aluminum.

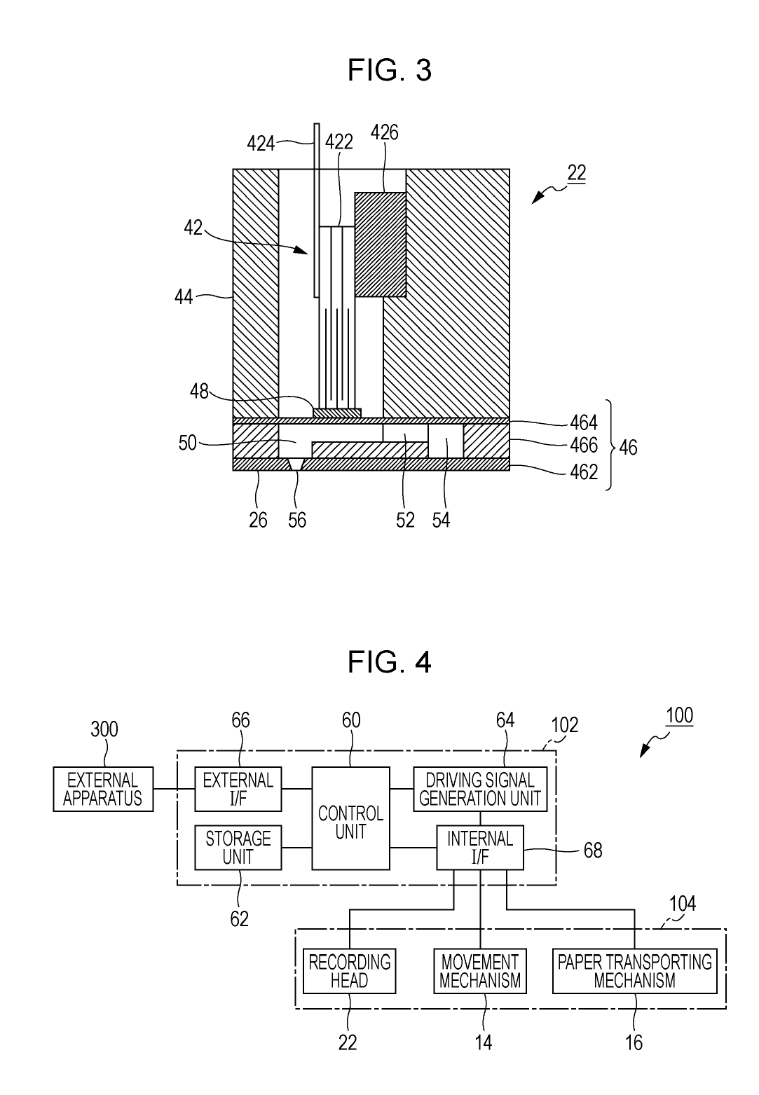

FIG. 3 is a cross-sectional diagram of the recording head 22 (cross-section orthogonal to the main scanning direction). As shown in FIG. 3, the recording head 22 is provided with a vibrating unit 42, an accommodating body 44 and a flow path unit 46. The vibrating unit 42 includes a piezoelectric vibrator 422, a cable 424, and a fixing plate 426. The piezoelectric vibrator 422 is a longitudinal vibration type piezoelectric element, in which piezoelectric material and electrodes are alternately stacked, and vibrates in response to a signal supplied through the cable 424. The vibration unit 42 is accommodated in the accommodating body 44 in a state where the fixing plate 426 to which the piezoelectric vibrator 422 is fixed is bonded to the inner wall surface of the accommodating body 44.

The flow path unit 46 has a structure in which the flow path forming plate 466 is inserted in the gap between the substrate 462 and the substrate 464 which face each other. The flow path forming plate 466 forms a space including the pressure chamber 50, the supply path 52 and the storage chamber 54 in the gap between the substrate 462 and the substrate 464. The pressure chamber 50 is divided into separate partitions for each vibration unit 42 and communicates with the storage chamber 54 through the supply path 52. A plurality of nozzles (discharge outlets) 56 corresponding to each pressure chamber 50 is formed in a row on the substrate 462. The discharge surface 26 is on the opposite side to the pressure chamber 50 of the substrate 462. Each nozzle 56 is a through hole communicating with the outside of the pressure chamber 50. The ink supplied from the ink cartridge 24 is stored in the storage chamber 54. As will be understood from the above description, an ink flow path is formed from the storage chamber 54 to the outside by way of the supply path 52, the pressure chamber 50, and the nozzles 56.

The substrate 464 is made of a plate material that is formed of an elastic material. In the region of the opposite side to the pressure chamber 50 in the substrate 464, an island shaped island portion 48 is formed. The substrate 464 and the island portion 48 which configure a part of the pressure chamber 50 are deformed by the driving of the piezoelectric vibrator 422 and vibrate to become a vibrating plate. In the island portion 48, the leading surface (free edge) of the piezoelectric vibrator 422 is bonded. Accordingly, when the piezoelectric vibrator 422 is driven by the supply of the signal, by displacing the substrate 464 through the island portion 48, the volume of the pressure chamber 50 is changed and the pressure of the ink in the pressure chamber 50 is varied. That is, the piezoelectric vibrator 422 functions as a pressure generating unit varying the pressure in the pressure chamber 50. It is possible to eject ink from the nozzle 56 according to the change in pressure in the pressure chamber 50 as described above.

FIG. 4 is a block diagram of an electric configuration of the printing apparatus 100. As shown in FIG. 4, the printing apparatus 100 is provided with a control apparatus 102 and a print processing unit (printing engine) 104. The control apparatus 102 is an element controlling the entire printing apparatus 100 and includes a control unit 60, a storage unit 62, a driving signal generation unit 64, an external I/F (interface) 66, and an internal I/F 68. Print data DP showing an image to be printed on recording paper 200 is supplied to the external I/F 66 from an external apparatus (for example, a host computer) 300 and the print processing unit 104 is connected to the internal I/F 68. The print processing unit 104 is an element recording an image on recording paper 200 under the control of the control apparatus 102 and includes the previously mentioned recording head 22, the movement mechanism 14 and the paper transporting mechanism 16.

The storage unit 62 includes ROM storing computer programs and the like and RAM temporarily storing various types of data used in image printing. The control unit 60 performs overall control of each element (for example, the print processing unit 104) of the printing apparatus 100 by executing the control program stored in the storage unit 62. Further, the control unit 60 generates control data DC for each printing cycle T indicating one of: ejection driving ejecting ink in the pressure chamber 50 from the nozzle 56 based on the print data DP supplied from the external I/F 66; micro-vibration driving (non-ejection) providing micro-vibration to the meniscus of the ink in the nozzle 56; or a standby state in which the displacement of the piezoelectric vibrator 422 is stopped (a state in which neither ejection driving nor micro-vibration driving are performed).

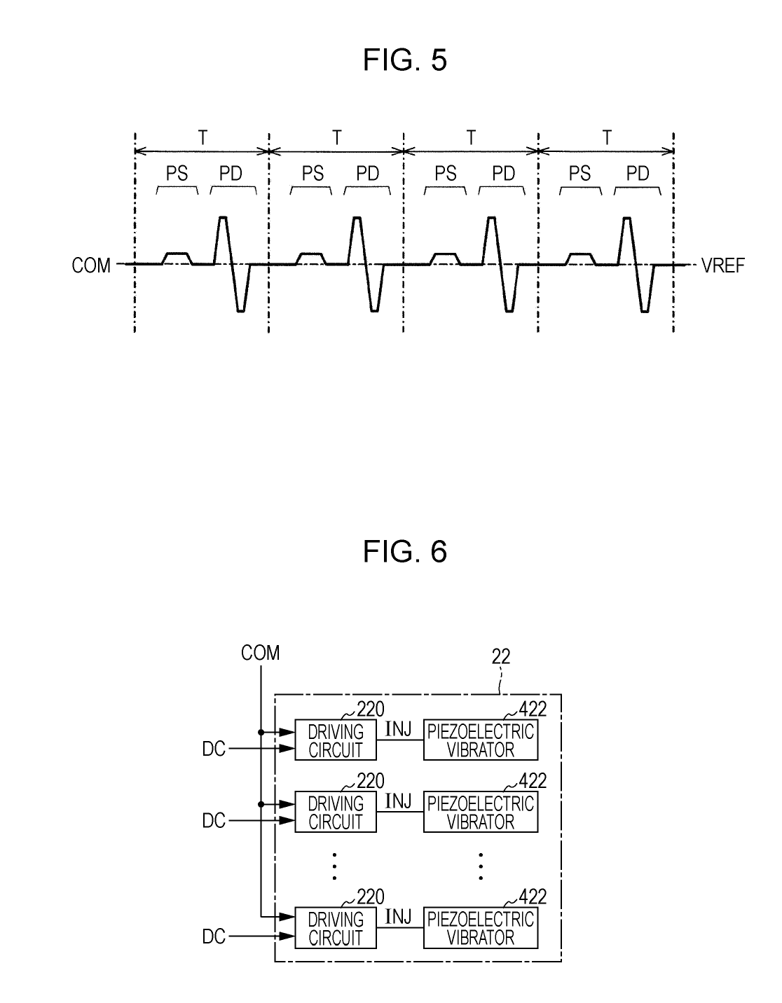

The driving signal generation unit 64 generates a driving signal COM driving the piezoelectric vibrator 422. An example of the driving signal COM is shown in FIG. 5. The driving signal COM is a cyclic signal having a constant frequency F. The micro-vibration driving pulse PS and the ejection pulse PD are arranged in one cycle (printing cycle T) of the driving signal COM. The micro-vibration pulse PS is a waveform of a trapezoidal shape vibrating the liquid surface (meniscus) of the ink in the nozzle 56 to an extent at which ink in the pressure chamber 50 is not ejected (that is, performing micro-vibration driving). The ejection pulse PD is a waveform deforming the piezoelectric vibrator 422 and the elastic film 43 such that a predetermined amount of ink in the pressure chamber 50 is ejected from the nozzle 56. The ejection pulse PD includes an interval in which the potential is changed from the predetermined reference potential VREF to a high side, an interval in which the potential is changed to a low side covering the reference potential VREF, and an interval in which the potential is changed to the high side and returned to the reference potential VREF. Here, the waveforms of the micro-vibration pulse PS and the ejection pulse PD may be appropriately changed.

FIG. 6 is a schematic diagram of an electric configuration of the recording head 22. As shown in FIG. 6, the recording head 22 is provided with a plurality of driving circuits 220 corresponding to each piezoelectric vibrator 422. The driving signal COM generated by the driving signal generation unit 64 is supplied in common to the plurality of driving circuits 220 through the internal I/F 68. Further, the control data DC generated by the control unit 60 is supplied to each driving circuit 220 through the internal I/F 68.

Each driving circuit 220 selects the driving signal COM according to the control data DC and performs supply thereof to the piezoelectric vibrator 422 as an ejection signal INJ. Specifically, when the control data DC instructs ejection driving, the driving circuit 220 selects the ejection pulse PD in the driving signal COM and performs supply thereof to the piezoelectric vibrator 422. The piezoelectric vibrator 422 is displaced by the supply of the ejection pulse PD and applies pressure to the ink in the pressure chamber 50, whereby ink is ejected from the nozzle 56 onto the recording paper 200. Further, when the control data DC instructs micro-vibration driving, the driving circuit 220 selects the micro-vibration pulse PS in the driving signal COM and performs micro-vibration driving at the piezoelectric vibrator 422, whereby micro-vibration is applied to the meniscus of the ink in the nozzle 56. Further, when the control data DC instructs the standby state, the driving circuit 220 does not select the ejection pulse PD or the micro-vibration pulse PS. Accordingly, the potential is maintained at the reference potential VREF and the ink is not ejected and the micro-vibration driving is not performed.

Here, when the control data DC instructs the standby state, the driving circuit 220 is preferably configured to supply a predetermined potential to the piezoelectric vibrator 422 (reference potential VREF or the like).

Incidentally, the appropriate frequency for ejecting ink from each nozzle 56 differ according to the characteristics of the ink. Specifically, when an ejection pulse PD corresponding to the photoluminescent ink is supplied to the piezoelectric vibrator 422 at the same frequency as the frequency at which the ejection pulse PD corresponding to the non-photoluminescent ink is supplied to the piezoelectric vibrator 422, photoluminescent ink with characteristics different to the expected ejection characteristics (ejection amount and flight speed) may or may not be ejected. Thus, in the first embodiment, the driving cycle of the piezoelectric vibrator 422 is made different according to the type of ink filled in the pressure chamber 50.

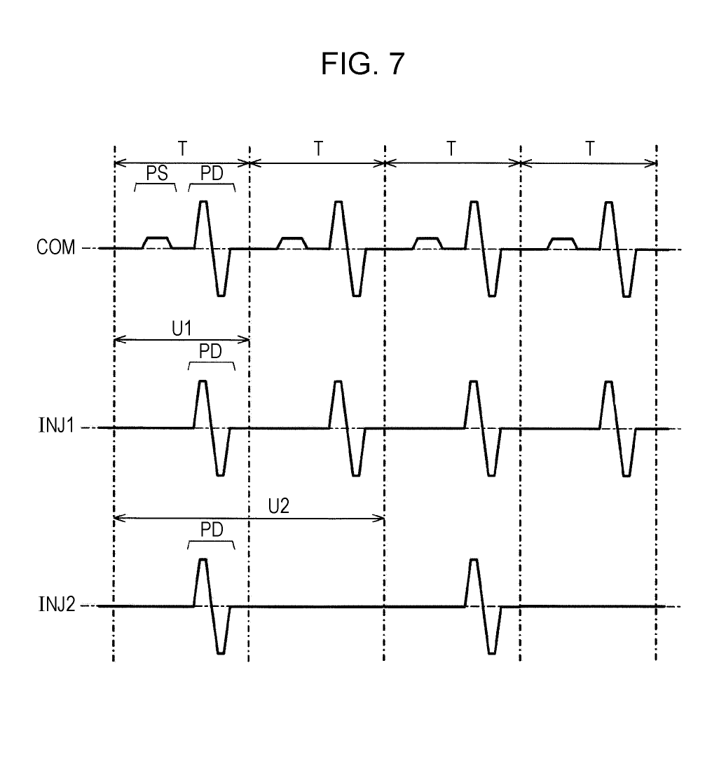

In FIG. 7, the ejection signal INJ1 to be supplied to the piezoelectric vibrator 422 corresponding to the non-photoluminescent ink is exemplified. As may be understood from FIG. 7, regarding the piezoelectric vibrator 422 corresponding to the non-photoluminescent ink, the control unit 60 generates control data DC instructing one of the ejection driving and the micro-vibration driving for each printing cycle T and performs supply thereof to the driving circuit 220. That is, in the piezoelectric vibrator 422 corresponding to the non-photoluminescent ink, ejection driving or micro-vibration driving is instructed for each printing cycle T. Accordingly, as shown in FIG. 7, in the piezoelectric vibrator 422 corresponding to the non-photoluminescent ink, an ejection pulse PD (or a micro-vibration pulse PS) for each printing cycle T may be supplied. That is, the cycle U1 of the ejection signal INJ1 supplied to the piezoelectric vibrator 422 corresponding to the non-photoluminescent ink (a cycle in which non-photoluminescent ink is ejected from one nozzle 56) equates to one printing cycle T, and the frequency of the ejection signal INJ1 is the same as the frequency F of the driving signal COM.

On the other hand, the ejection signal INJ2 of FIG. 7 is an example of the ejection signal INJ supplied to the piezoelectric vibrator 422 corresponding to the photoluminescent ink. As may be understood from FIG. 7, regarding the photoluminescent ink, the control unit 60 generates control data DC instructing one of ejection driving or micro-vibration driving every other printing cycle T, and generates control data DC instructing the standby state in the other printing cycles T. That is, in the piezoelectric vibrator 422 corresponding to the photoluminescent ink, one of the ejection driving and the micro-vibration driving, or the standby state is instructed alternately for each printing cycle T. Accordingly, as shown in FIG. 7, in the piezoelectric vibrator 422 corresponding to the photoluminescent ink, the ejection pulse PD (or the micro-vibration pulse PS) is supplied every other printing cycle T and the standby state in maintained in the other printing cycles T. That is, the cycle U2 of the ejection signal INJ2 supplied to the piezoelectric vibrator 422 corresponding to the photoluminescent ink (a cycle in which photoluminescent ink is ejected from one nozzle 56) equates to two printing cycles T, and the frequency of the ejection signal INJ2 is half the frequency F ((½) F) of the driving signal COM.

Furthermore, as described above, the frequency at which the photoluminescent ink is ejected from one nozzle 56 is half that of the non-photoluminescent ink; however, as previously stated with reference to FIG. 2, since the nozzle group 28G corresponding to the non-photoluminescent ink is configured with twice as many nozzles 56 as each nozzle group 28 corresponding to the photoluminescent ink, focussing on one nozzle group 28, the ejection frequency of the ink for a single unit of time is the same for both the photoluminescent ink and the non-photoluminescent ink.

In the first embodiment described above, since the piezoelectric vibrator 422 corresponding to the photoluminescent ink is driven with a low frequency in comparison with the piezoelectric vibrator 422 corresponding to the non-photoluminescent ink, there is an advantage in that fast ejection of the photoluminescent ink and appropriate ejection of the non-photoluminescent ink can be made compatible in comparison to a configuration in which the frequency driving the piezoelectric vibrator 422 (frequency of the ejection signal INJ) is the same for the photoluminescent ink and the non-photoluminescent ink. Specifically, in comparison with a case in which non-photoluminescent ink is ejected in a cycle U2 capable of appropriately ejecting photoluminescent ink, fast ejection of non-photoluminescent ink is realized. Further, in comparison with a case in which photoluminescent ink is ejected in a cycle U1 capable of quickly ejecting non-photoluminescent ink, it is possible to appropriately eject photoluminescent ink with desired ejection characteristics.

Furthermore, regarding the nozzle group 28 corresponding to the photoluminescent ink ejected by the ejection signal INJ2 of which the frequency is low, since many nozzles 56 are provided in comparison with each nozzle group 28 corresponding to the non-photoluminescent ink ejected by the ejection signal INJ1 of which the frequency is high, it is possible to eject the photoluminescent ink at the same ejection frequency as the ejection frequency of the non-photoluminescent ink.

### B: Second Embodiment

Below, description will be given of the second embodiment of the invention. In each embodiment illustrated below, the reference numerals referred to in the above description are also applied to the elements having the same effect and function as the first embodiment and overlapping description thereof is omitted.

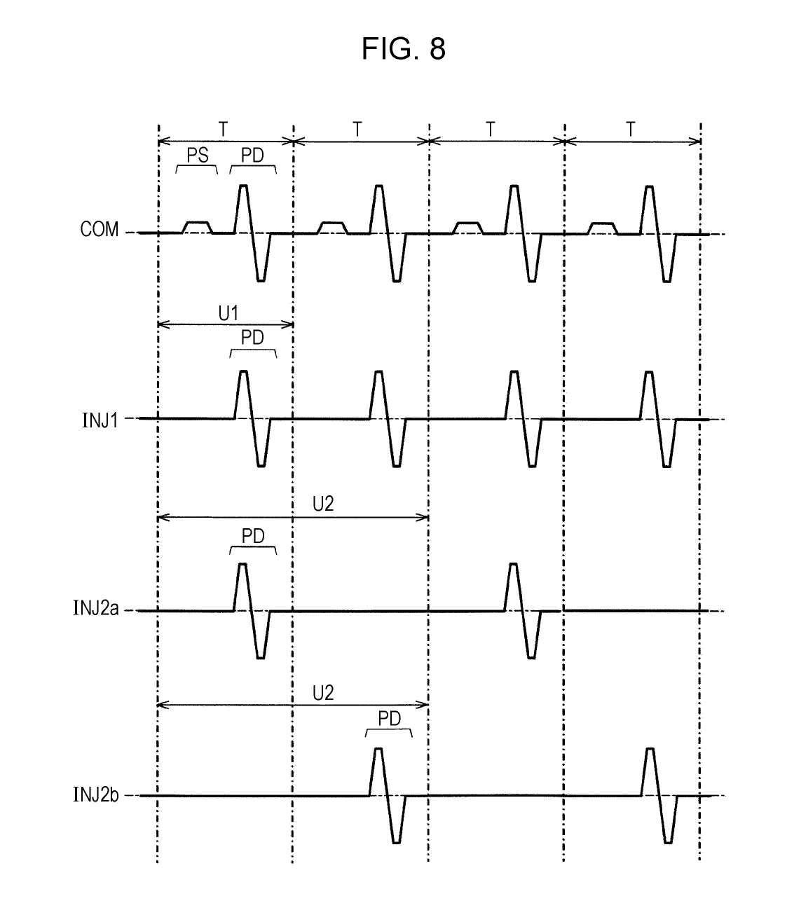

The ejection signal INJ2a of FIG. 8 is an example of an ejection signal supplied to each piezoelectric vibrator 422 corresponding to the first row La of nozzles 56 in the nozzle group 28G corresponding to the photoluminescent ink. The ejection signal INJ2b of FIG. 8 is an example of an ejection signal supplied to each piezoelectric vibrator 422 corresponding to the second row Lb of nozzles 56 in the nozzle group 28G. The point that the frequency of the ejection signal INJ2 (INJ2a, INJ2b) supplied to the piezoelectric vibrator 422 corresponding to the photoluminescent ink is half the frequency ((½) F) of the ejection signal INJ1 supplied to the piezoelectric vibrator 422 corresponding to the non-photoluminescent ink is the same as the first embodiment.

As shown in FIG. 8, regarding each nozzle 56 of the first row La, the control unit 60 alternately generates control data DC instructing ejection driving or micro-vibration driving and control data DC instructing the standby state for each printing cycle T. On the other hand, regarding the second row Lb of each nozzle 56, in the printing cycle T in which ejection driving or micro-vibration driving is instructed with respect to each nozzle 56 of the first row La, the control unit 60 generates control data DC instructing the standby state, and, in the printing cycle T in which the standby state is instructed with respect to each nozzle 56 of the first row La, the control unit 60 generates control data DC instructing ejection driving or micro-vibration driving. Accordingly, in each piezoelectric vibrator 422 corresponding to the first row La and in each piezoelectric vibrator 422 corresponding to the second row Lb, an ejection pulse PD (or a micro-vibration pulse PS) is supplied in different printing cycles T. That is, in the piezoelectric vibrator 422 corresponding to the first row La, the ejection pulse PD is supplied in the odd numbered printing cycles T and in the piezoelectric vibrator 422 corresponding to the second row Lb, an ejection pulse PD is supplied in the even numbered printing cycles T.

Accordingly, looking at one printing cycle T, since control data DC instructing one of ink ejection or micro-vibration driving is supplied in the driving circuit 220 of the first row La and the driving circuit 220 of the second row Lb and control data DC instructing the standby state is supplied in the other, the ejection pulse PD or the micro-vibration pulse PS is provided for only one of the ejection signal INJ2a and the ejection signal INJ2b.

According to the above configuration, the same effect as the first embodiment is realized. Furthermore, since the period of driving each piezoelectric vibrator 422 is divided between the first row La and the second row Lb, the driving load of the recording head 22 is reduced in comparison with a configuration supplying the ejection pulse PD at the same time with respect to all of the piezoelectric vibrators 422 corresponding to each nozzle 56 of the nozzle group 28G. Further, since the number of piezoelectric vibrators 422 to which the ejection pulse PD is supplied at the same time is reduced (the storage components attached to the transmission path of the driving signal COM are reduced), there is an advantage in that distortion of the driving signal COM is suppressed.

### C: Third Embodiment

In the above embodiments, the driving signal generation unit 64 generated a single driving signal COM. In the third embodiment, the driving signal generation unit 64 generates a plurality of driving signals.

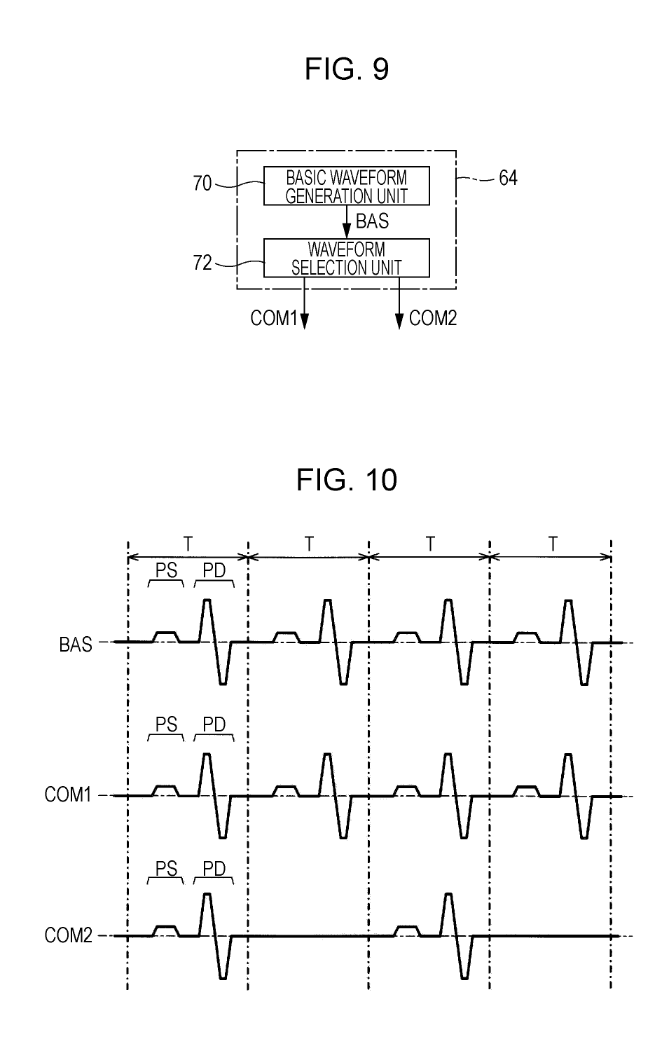

Description will be given of the electric configuration of the driving signal generation unit 64 of the third embodiment with reference to FIG. 9. The driving signal generation unit 64 of the third embodiment is provided with a basic waveform generation unit 70 and a waveform selection unit 72. The basic waveform generation unit 70 generates a basic waveform BAS and performs supply thereof to the waveform selection unit 72. The waveform selection unit 72 selects the entirety or a part of the basic waveform BAS and generates a plurality of driving signals COM (first driving signal COM1 and second driving signal COM2).

FIG. 10 shows an example of the basic waveform BAS and the driving signal COM of the third embodiment. The basic waveform BAS is a cyclic signal having a constant frequency F. The micro-vibration driving pulse PS and the ejection pulse PD are arranged in one cycle (printing cycle T) of the driving signal COM. The waveform selection unit 72 selects all the intervals of the basic waveform BAS, generates the first driving signal COM1 and performs supply thereof to the driving circuit 220 corresponding to the non-photoluminescent ink. Further, the waveform selection unit 72 selects the basic waveform BAS every other printing cycle T, generates the second driving signal COM2 and performs supply thereof to the driving circuit 220 corresponding to the photoluminescent ink. The length of time of one cycle of the first driving signal COM1 is equal to the length of time of one cycle (printing cycle T) of the basic waveform BAS, and the frequency of the first driving signal COM1 is equal to the frequency F of the basic waveform BAS. Further, the length of time of one cycle of the second driving signal COM2 is twice the length of time (2T) of one cycle of the basic waveform BAS (printing cycle T), and the frequency of the second driving signal COM2 is half ((½) F) of the frequency F of the basic waveform BAS.

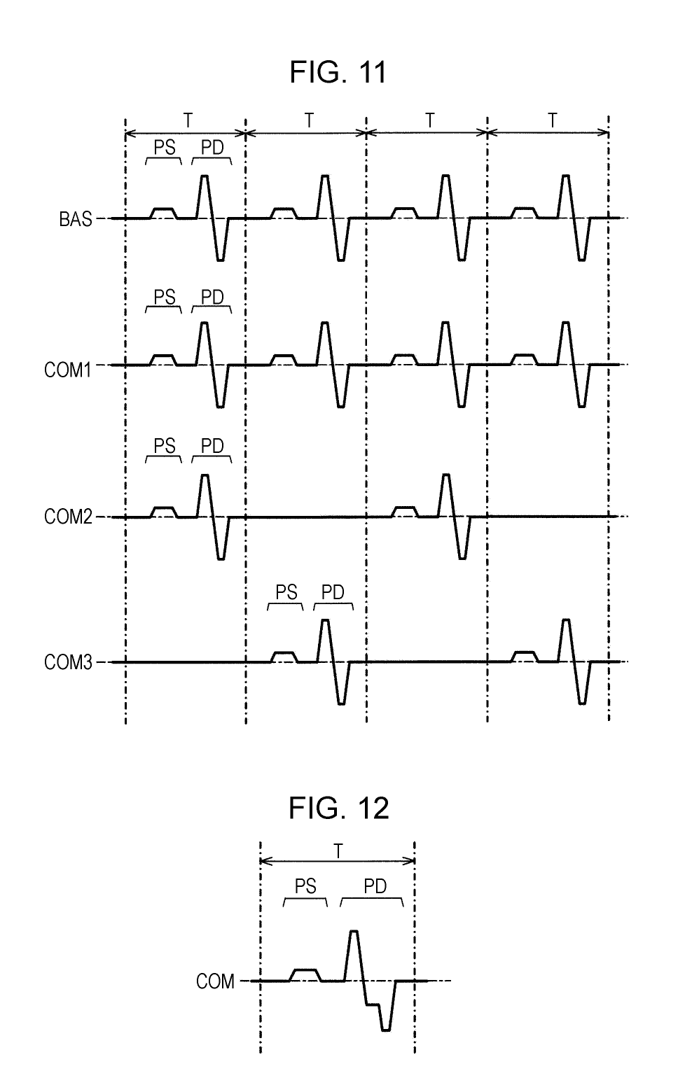

In the above configuration, the same effect as the first embodiment is realized. Further, in the configuration of the second embodiment in which the ejection signal is made different for each nozzle row L ejecting photoluminescent ink, it is preferable to employ the above configuration. That is, as shown in FIG. 11, the first driving signal COM1 supplied to the driving circuit 220 corresponding to the non-photoluminescent ink, the second driving signal COM2 supplied to the driving circuit 220 of the first row La, and the third driving signal COM3 supplied to the driving circuit 220 of the second row Lb may be generated by the waveform selection unit 72. The second driving signal COM2 and the third driving signal COM3 are signals in which different intervals (printing cycles T) in the basic waveform BAS are selected, the length of time of one cycle is twice that of the printing cycle T (2T), and the frequency is half the frequency F ((½) F). In such a configuration, the same effect as the second embodiment is realized.

### D: Modification

The above embodiments may be modified in various ways. Specific embodiments of the modifications are illustrated below. Two or more embodiments arbitrarily selected from those illustrated below may be appropriately combined as long as there is no conflict in so doing.

### 1. Modification 1

In the third embodiment, the driving signal generation unit 64 generated a plurality of driving signals from the common basic waveform BAS (first driving signal COM1 and second driving signal COM2). However, the plurality of driving signal generation units 64 may generate a plurality of driving signals separately. For example, the first driving signal generation unit 64A may generate the first driving signal COM1 of the frequency F, and the second driving signal generation unit 64B may generate the second driving signal COM2 of a frequency lower than the frequency F.

### 2. Modification 2

The wave height and the waveform of each pulse of the driving signal COM (basic waveform BAS) are arbitrary. For example, the ejection pulse PD of FIG. 5 has one element (pressure adding element) changing the potential to a low side; however, as shown in FIG. 12, an ejection pulse PD having two pressure adding elements connected by a potential maintaining element may be adopted. Further, according to the displacement characteristics of the piezoelectric vibrator 422 (the relationship of adding and reducing pressure and high and low potential), it is also possible to adopt a driving signal COM in which the waveform of the driving signal COM of FIG. 5 is reversed with respect to the reference potential VREF.

### 3. Modification 3

Each nozzle group 28 other than the nozzle group 28G may have a plurality of nozzle rows L. Further, the nozzle group 28G may have three or more nozzle rows L. That is, the nozzles 56 in the nozzle group 28 may be arranged at arbitrary positions.

### 4. Modification 4

The configuration of the element changing the pressure in the pressure chamber 50 (the pressure generating element) is not limited to the above examples. For example, it is also possible to use a vibrator such as an electrostatic actuator. Further, the pressure generating element according to an aspect of the invention is not limited to elements applying mechanical vibration to the pressure chamber 50. For example, it is also possible to use a heat generating element (heater), which changes the pressure inside the pressure chamber 50 by generating bubbles by heating the pressure chamber 50, as the pressure generating element. That is, the pressure generating element according to an aspect of the invention includes all elements changing the pressure in the pressure chamber 50, and the method of changing the pressure (piezo type or thermal type) and the configuration do not matter.

### 5. Modification 5

In the above embodiments, the frequency of the ejection signal INJ1 ejecting non-photoluminescent ink and the frequency of the ejection signal INJ2 ejecting photoluminescent ink are made to be different; however, the type of liquid that is the target of the differentiated ejection signal frequencies is arbitrary. That is, the configuration according to an aspect of the invention may be adopted in a liquid ejecting apparatus ejecting a plurality of liquids having different characteristics.

### 6. Modification 6

The printing apparatus 100 of the above embodiments may be employed as various types of devices such as a plotter, a facsimile machine, and a copier. However, the purpose of the liquid ejecting apparatus according to an aspect of the invention is not limited to image printing. For example, a liquid ejecting apparatus ejecting a solution of various colors may be used as a manufacturing apparatus forming a color filter for a liquid crystal display apparatus. Further, a liquid ejecting apparatus ejecting a liquid state conductive material may be used as an electrode manufacturing apparatus forming electrodes of a display apparatus such as an organic EL (Electroluminescence) display apparatus and a FED display apparatus (FED: Field Emission Display), for example. Further, a liquid ejecting apparatus ejecting a solution of a bio-organic substance may be used as a chip manufacturing apparatus manufacturing biochemical elements (biochips, micro-arrays).

Further, in the above embodiments, a serial type printing apparatus 100 in which a carriage 12 mounted with a recording head 22 is moved in the main scanning direction; however, it is possible to apply the invention to a printing apparatus using a line type recording head configured to have a long shape in the main scanning direction so that a plurality of nozzles are arranged across the entire width direction of the recording paper.

The entire disclosure of Japanese Patent Application No. 2011-041499, filed Feb. 28, 2011 is expressly incorporated by reference herein.

What is claimed is:

1. A liquid ejecting apparatus comprising:
a recording head including a first pressure chamber filled with a first liquid, a first nozzle that communicates with the first pressure chamber, a first pressure generating element that changes pressure in the first pressure chamber and ejects the first liquid in the first pressure chamber from the first nozzle, and a second pressure chamber filled with a second liquid, a second nozzle that communicates with the second pressure chamber, and a second pressure generating element that changes pressure in the second pressure chamber and ejects the second liquid in the second pressure chamber from the second nozzle; and
a control unit that supplies an ejection pulse of a first frequency to the first pressure generating element to eject the first liquid from the first nozzle, and supplies an ejection pulse of a second frequency lower than the first frequency to the second pressure generating element to eject the second liquid from the second nozzle.

2. The liquid ejecting apparatus according to claim 1, wherein the number of nozzles that eject the second liquid is greater than the number of the first nozzles.

3. The liquid ejecting apparatus according to claim 1 further comprising:
a driving signal generation unit that generates a driving signal including the ejection pulse of each driving cycle,
wherein the control unit instructs the supply of the ejection pulse of each of the driving cycles with respect to the first pressure generating element and instructs the supply of the ejection pulse every predetermined number of driving cycles with respect to the second pressure generating element.

4. The liquid ejecting apparatus according to claim 1,
wherein the recording head further includes a third pressure chamber filled with the second liquid, a third nozzle communicated with the second pressure chamber, and a third pressure generating element that changes the pressure in the third pressure chamber and ejects the second liquid in the third pressure chamber from the third nozzle, and
wherein the control unit supplies an ejection pulse of a first driving cycle in a plurality of driving cycles to the second pressure generating element, and supplies an ejection pulse of a second driving cycle different to the first driving cycle in the plurality of driving cycles to the third pressure generating element.

5. The liquid ejecting apparatus according to claim 1, wherein the second liquid is photoluminescent ink.

6. The liquid ejecting apparatus according to claim 5, wherein the photoluminescent ink contains photoluminescent pigment and has a lower viscosity than the first liquid.

7. The liquid ejecting apparatus according to claim 6, wherein the photoluminescent pigment is plate-shaped particles.

8. A driving method for a liquid ejecting apparatus including
a recording head provided with a first pressure chamber filled with a first liquid, a first nozzle that communicates with the first pressure chamber, a first pressure generating element that changes the pressure in the first pressure chamber and ejects the first liquid in the first pressure chamber from the first nozzle, and a second pressure chamber filled with a second liquid, a second nozzle that communicates with the second pressure chamber, and a second pressure generating element that changes the pressure in the second pressure chamber and ejects the second liquid in the second pressure chamber from the second nozzle, the method comprising:
supplying an ejection pulse of a first frequency to the first pressure generating element to eject the first liquid from the first nozzle; and
supplying an ejection pulse of a second frequency lower than the first frequency to the second pressure generating element to eject the second liquid from the second nozzle.
